(19) United States
(12) Patent Application Publication
(10) Pub. No.: US 2015/0110338 A1
(43) Pub. Date: Apr. 23, 2015

(54) Shock Resistant Coil And Receiver

(71) Applicant: Knowles Electronics, LLC, Itasca, IL (US)

(72) Inventors: Michael McCratic, Cary, IL (US); Matthew Mason, Algonquin, IL (US); Ryan Grounds, Lake In The Hills, IL (US); Dennis R. Kirchhoefer, Plainfield, IL (US); Thomas E. Miller, Arlington Heights, IL (US); Henry G. Nepomuceno, Elk Grove Village, IL (US); Shehab Albahri, Hanover Park, IL (US)

(21) Appl. No.: 14/509,542

(22) Filed: Oct. 8, 2014

Related U.S. Application Data
(60) Provisional application No. 61/892,112, filed on Oct. 17, 2013.
(60) Provisional application No. 61/945,968, filed on Feb. 28, 2014.

(51) Int. Cl. H04R 9/02

(52) U.S. Cl. CPC H04R 9/025
USPC 381/417

(57) ABSTRACT

A motor includes an armature, a coil, and a magnetic support structure. The motor also includes at least one magnet that defines a space. The coil forms a tunnel. The space is defined by the at least one magnet being aligned with the tunnel formed by the coil. Portions of the armature extend through the space and the tunnel. An opening at an end of the coil is shaped so as to restrict movement of the armature.

### CROSS REFERENCE TO RELATED APPLICATIONS

This patent claims benefit under 35 U.S.C. §119 (e) to U.S. Provisional Application No. 61892112 entitled “Shock Resistant Coil and Receiver” filed Oct. 17, 2013, and Application No. 61945968 entitled “Shock Resistant Coil and Receiver” filed Feb. 28, 2014 the contents of both of which are incorporated herein by reference in their entireties.

### TECHNICAL FIELD

This application relates to acoustic devices and, more specifically, to shock absorption aspects of these devices.

### BACKGROUND OF THE INVENTION

Various types of microphones and receivers have been used through the years. In these devices, different electrical components are housed together within a housing or assembly. Other types of acoustic devices may include other types of components. These devices may be used in hearing instruments such as hearing aids or in other electronic devices such as cellular phones and computers.

The receiver motor typically includes a coil, a yoke, an armature (or reed), and magnets. An electrical signal applied to the coil and creates a magnetic field within the motor which causes the armature to move. Movement of the armature causes movement of a diaphragm, which creates sound. Together, the magnets, armature, and yoke form a magnetic circuit. The yoke may also serve to hold or support the magnets or other components.

As mentioned, receivers are utilized in various types of applications. In many of these applications, the equipment that houses the receiver can be shaken, dropped, or otherwise receive potentially damaging mechanical shocks or forces. Without measures to absorb the shocks, the components of the receiver can be come damaged. If the receiver components become damaged, then the receiver potentially will not operate properly. Although there have been previous attempts at providing receivers that can handle shocks or other mechanical forces, these previous attempts have often used complicated procedures or additional structure that was costly to install. Consequently, there has been some user dissatisfaction with previous approaches.

### BRIEF DESCRIPTION OF THE DRAWINGS

For a more complete understanding of the disclosure, reference should be made to the following detailed description and accompanying drawings wherein:

FIG. 1 comprises a perspective view of a receiver according to various embodiments of the present invention;

FIG. 2 comprises a side cut away view of the receiver of FIG. 1 taken along line A-A according to various embodiments of the present invention;

FIGS. 3A, 3B, and 3C comprise end views of the receivers of FIG. 1 and FIG. 2 showing one shape for the coil and coil tunnel according to various embodiments of the present invention;

FIGS. 4A, 4B, and 4C comprise end views of the receivers of FIG. 1 and FIG. 2 showing another shape for the coil and coil tunnel according to various embodiments of the present invention;

FIG. 5 comprises a perspective view of a coil according to various embodiments of the present invention;

FIG. 6 comprises a perspective view of a receiver according to various embodiments of the present invention;

FIG. 7 comprises a perspective view of a coil according to various embodiments of the present invention;

FIG. 8 comprises a top cutaway view of the coil of FIG. 7 according to various embodiments of the present invention;

FIG. 9 comprises a side cutaway section view of the coil of FIG. 7 and FIG. 8 according to various embodiments of the present invention;

FIG. 10 comprises a front view of the coil of FIGS. 7-9 according to various embodiments of the present invention;

FIG. 11 comprises a perspective view of a motor using the coil of FIGS. 7-10 according to various embodiments of the present invention;

FIG. 12 comprises a side cutaway section view of the motor of FIG. 11 according to various embodiments of the present invention;

FIG. 13 comprises a front view of the motor of FIG. 11 and FIG. 12 according to various embodiments of the present invention;

FIG. 14 comprises a front view of the motor of FIGS. 11-13 with the armature deflected in one direction according to various embodiments of the present invention;

FIG. 15 comprises a front view of the motor of FIGS. 11-13 with the armature deflected in a second direction according to various embodiments of the present invention;

FIGS. 16A-F comprise front views of coils according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The approaches described herein provide elongated coils (e.g., that have tunnels and a corresponding coil structure that are of an octagon shape or of a diamond shape) that provide shock protection for an armature. In this respect, as the armature moves in the tunnel it will contact the coil at two points rather than more than which at a single point of contact. One advantage of the present approaches is that wire selection and/or the shape of the coil/tunnel is used to achieve shock protection without the need of an epoxy modem or other additional external devices.

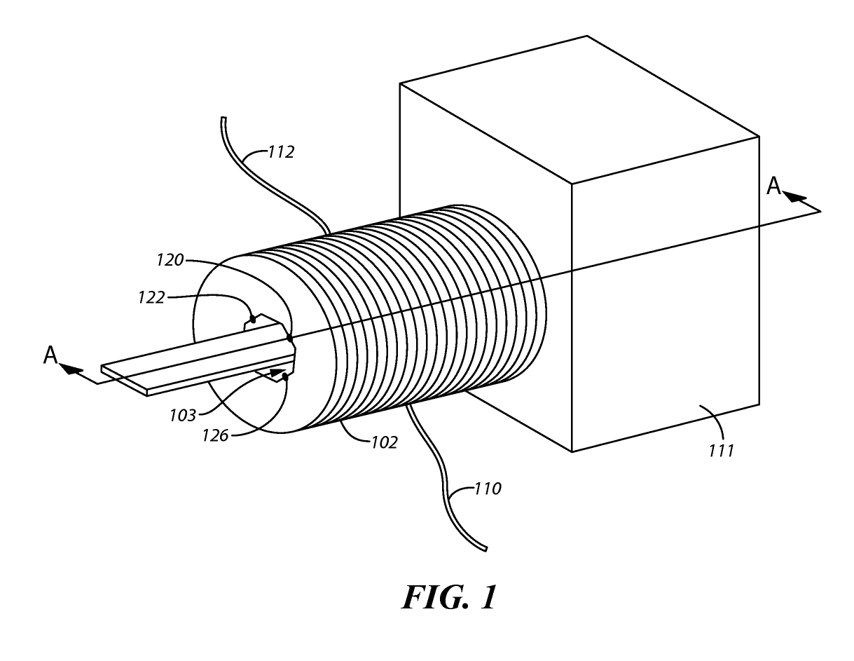

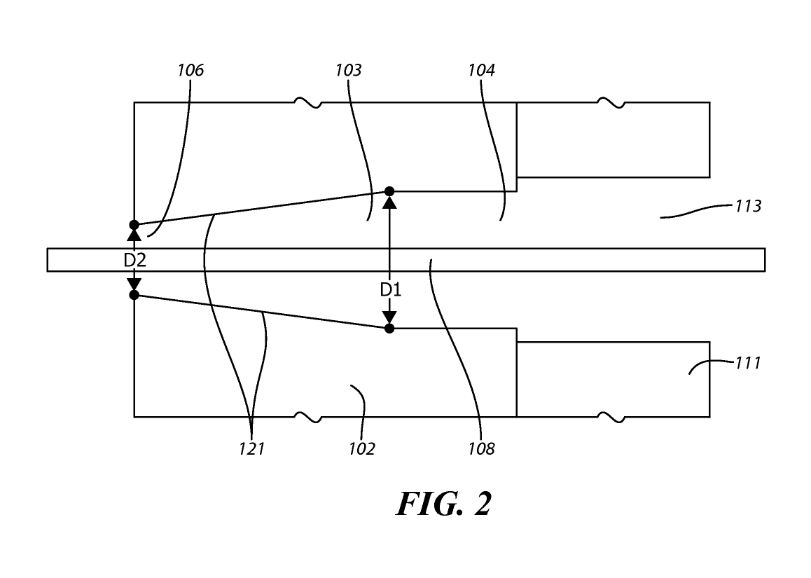

Referring now to FIGS. 1, 2, 3A-C, 4A-C, one example of a receiver apparatus 100 that includes an elongated coil 102 is described. The coil 102 is formed with a coil tunnel 103 that extends from a first side 104 to a second side 106 of the coil 102. A reed (also referred to an armature herein) 108 extends through the coil tunnel 103. A first wire 110 and a second wire 112 are coupled to the coil. The first wire 110 and the second wire 112 provide a path for electrical excitation signals and current to enter the coil 102.

The coil tunnel 103 tapers from the first side 104 to the second side 106. The coil tunnel 103 is generally octagonal in shape (looking into the tunnel from the side of the coil 102) corresponding to the same shape by which the interior structure of the coil 102 (i.e., the structure adjacent to the coil tunnel 103). It will be understood that if the reed 108 moves too far, the reed 108 will contact the coil 102 at points 120, 122, 124, and 126 on the coil 102. In other words, when there is a shock (or other force) applied to the reed 108, the reed 108 will contact the coil 102 (which is the shock absorber) at two of the four points (points 120 and 122, or points 124 and 126) and not over a larger area. Additionally, there are no epoxy bumps that are needed to act as the shock absorber. In other words, the geometry of the coil itself is used as the shock absorber without the need for using additional devices or materials (e.g., epoxy or glue bumps). It will also be understood that other shapes (e.g., hexagons and diamonds to mention two examples can also be used to shape the coil.

The coil 102 is coupled to or is disposed in close proximity to a stack portion 111. The stack portion 111 includes a stack tunnel 113 through which the reed 108 extends. As mentioned, the reed 108 also extends through the coil tunnel 103. It will be appreciated that the reed 108 may be a u-shaped reed and, in some examples, may be a flat reed.

In operation, an electrical current is applied to the coil (via the wires 110 and 112) and this creates a magnetic flux. The creation of the magnetic flux moves the armature 108 which in turn moves a rod (not shown). The rod is attached to a diaphragm (not shown) and movement of the rod causes movement of the diaphragm, which creates sound. The sound may be presented to a listener via a sound tube (in one example).

In operation, shocks are other unwanted forces might impact the coil 102. For example, the receiver (in which the coil is located) may itself be located in another device (e.g., a personal computer or cellular phone) and this device may be dropped producing an unwanted and potentially damaging force that impacts the coil 102. However, this shock or force is absorbed or dissipated by the coil 102 as has been generally described above.

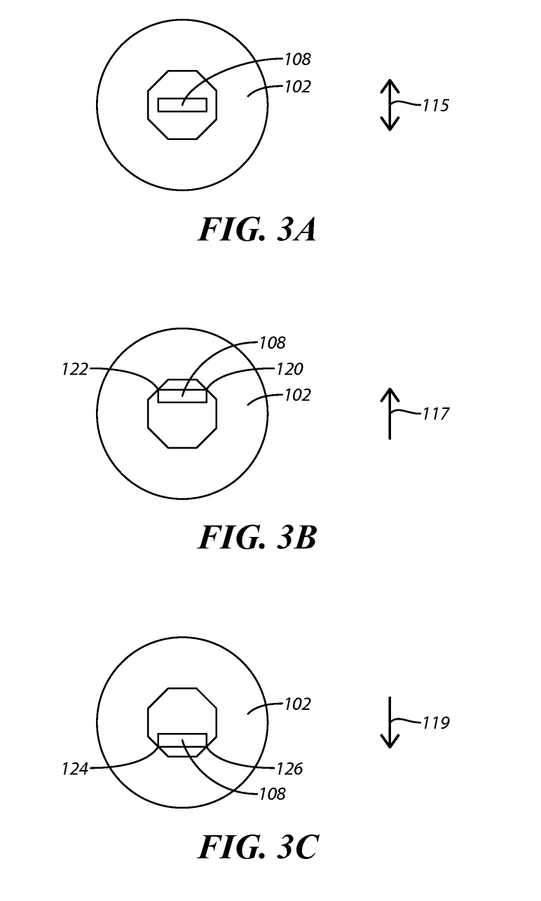

Referring now especially to FIGS. 3A, 3B, and 3C, a more detailed description of the shock absorption approaches presented herein is described. As shown in FIG. 3A, the placement of the reed 108 is shown where the reed 108 is generally disposed in the middle of the coil tunnel 103. The reed 108 may move in the direction indicated by the arrow 115. The reed 108 (in FIG. 3A) has not moved far enough to be in contact with any of the contact points 120, 122, 124, or 126.

As shown in FIG. 3B, the placement of the reed 108 is shown where the reed 108 moves upward in the direction indicated by the arrow labeled 117. The amount of movement by the reed 108 indicated by the arrow labeled 117 is sufficient so that the reed 108 comes into contact with contact points 120 and 122 of the coil 102. The reed 108 comes into contact at two points because the coil tunnel 103 is tapered presenting a face where the two points 120 and 122 are located.

As shown in FIG. 3C, the placement of the reed 108 is shown where the reed 108 moves downward in the direction indicated by the arrow labeled 119. The amount of movement by the reed 108 is sufficient so that the reed 108 comes into contact with contact points 124 and 126. The reed 108 comes into contact at two points because the coil tunnel 103 is tapered presenting a face where the two points 124 and 126 are located. Thus, the reed 108 does not impact a set of points (or region).

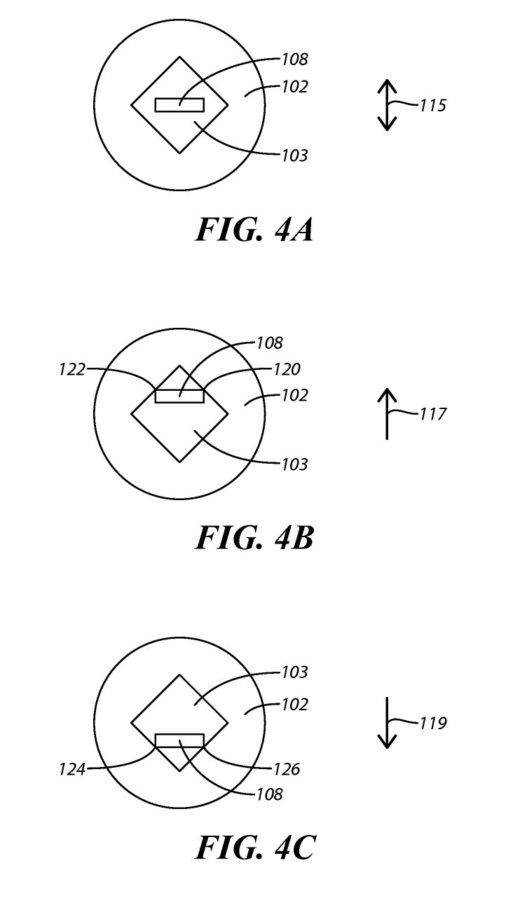

Referring now especially to FIGS. 4A, 4B, and 4C, a different configuration of the coil 102 is shown. In this case, a diamond-shaped configuration fro the coil 102 and coil tunnel 103 may also be used.

As shown in FIG. 4A, the placement of the reed 108 is shown where the reed 108 is generally disposed in the middle of the tunnel 103 and does not move far enough to impact the coil 102. It may move in the direction indicated by the arrow 115. As mentioned, the reed 108 has not moved far enough to be in contact with any of the contact points 120, 122, 124, or 126.

As shown in FIG. 4B, the placement of the reed 108 is shown where the reed 108 moves upward in the direction indicated by the arrow labeled 117. The amount of movement by the reed 108 is sufficient so that the reed 108 comes into contact with contact points 120 and 122. The reed 108 comes into contact at two points because the coil tunnel 103 is tapered presenting a face where the two points 120 and 122 are located.

As shown in FIG. 4C, the placement of the reed 108 is shown where the reed 108 moves downward in the direction indicated by the arrow labeled 119. The amount of movement by the reed 108 is sufficient so that the reed 108 comes into contact with contact points 124 and 126. The reed 108 comes into contact at two points because the coil tunnel 103 is tapered presenting a face where the two points 124 and 126 are located.

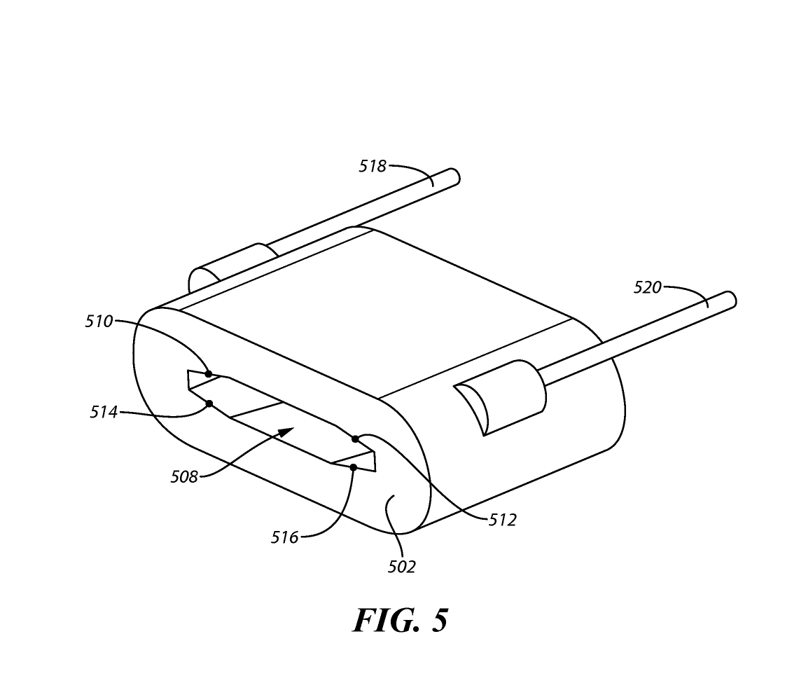

Referring now to FIG. 5, one example of a coil (without the stack or other elements of the receiver) is described. As shown, a coil 502 includes an opening 504 through which an armature (not shown) extends. An opening 506 in the coil 502 is generally octagonal in shape. As the armature moves it will come into contact points 510 and 512 (if it moves up) or 514 or 516 if it moves down. Wires 518 and 520 connect the coil to a current source. The other aspects of the coil of FIG. 5 have already been described above with respect to the coil 102 and will not be repeated here.

It will be appreciated that the coils and receivers provided herein may be constructed according to a variety of different processes and approaches. For instance, the coils can be manufactured using both a dry wind process. By a dry wind process it is meant that the coils are bonded and layered together by the use of induction, convection, and or conductive heating of the thermoset wire. By a wet wind process, it is meant that the coils are constructed by using epoxies, glues, and any other fluid, gel, or paste used as a binding agent. Generally speaking, a dry wind process is more controllable, less costly, and more repeatable.

The approaches described herein provide elongated coils (e.g., that have tunnels and a corresponding coil structure that are of an octagon shape or of a diamond shape) that provide shock protection for an armature. In this respect, as the armature moves in the tunnel it will contact the coil at two points rather than more than which at a single point of contact. One advantage of the present approaches is that wire selection and/or the shape of the coil/tunnel is used to achieve shock protection without the need of a molded epoxy or other additional external devices.

In operation, shocks are other unwanted forces might impact the coils. For example, the receiver (in which the coil is located) may itself be located in another device (e.g., a personal computer or cellular phone) and this device may be dropped producing an unwanted and potentially damaging force that impacts the coil. However, this shock or force is absorbed or dissipated by the coil as has been generally described above.

Approaches are described herein that provide receivers that can be used in various applications such as hearing instruments (HIs). The receivers described herein can also be deployed in other devices such as personal computers and cellular phones. Other examples of devices are possible.

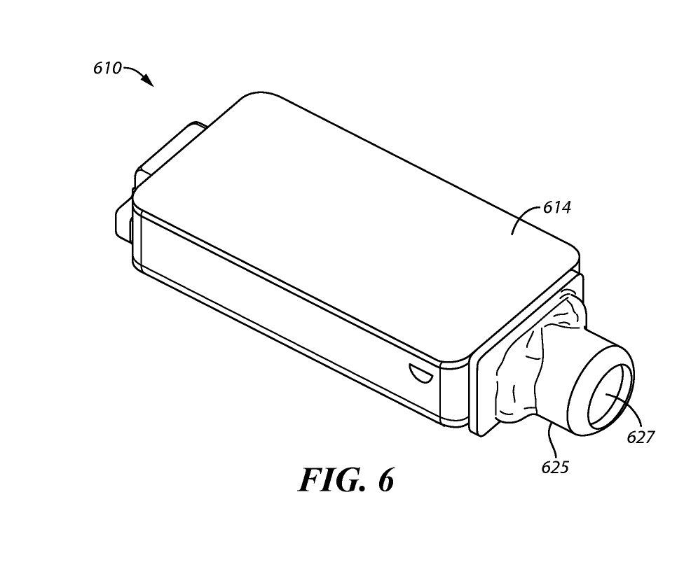

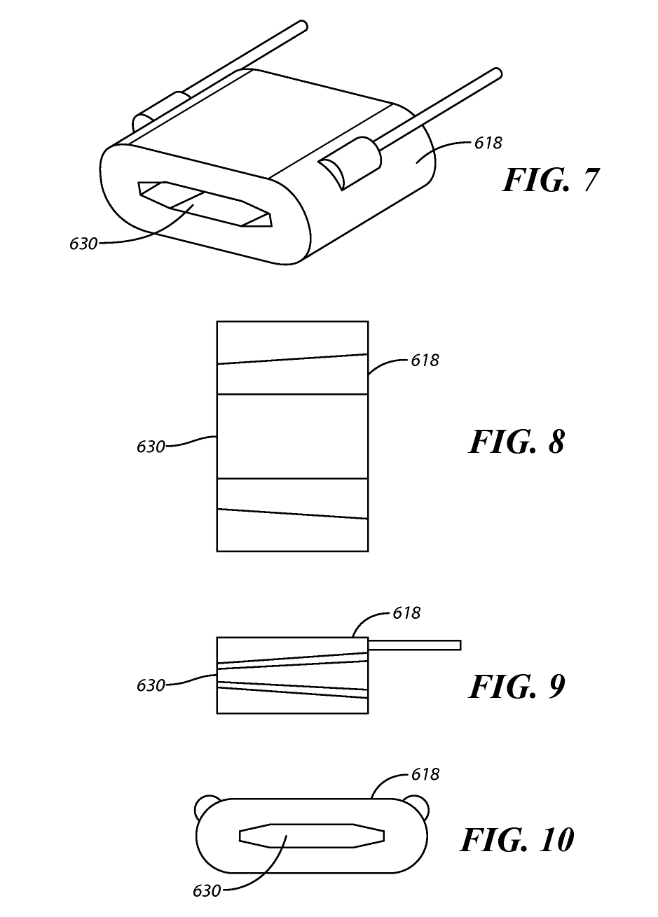

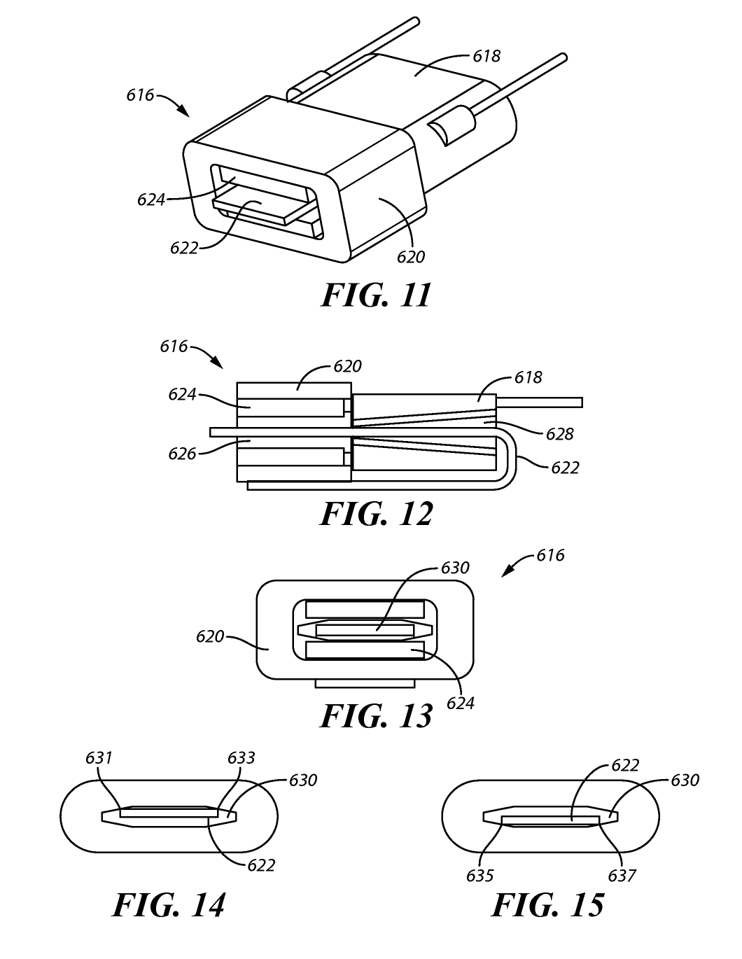

Referring now to FIGS. 6-16, examples of a receiver 610 are described. The receiver comprises a housing 614 defining an interior and an exterior. The receiver 610 further comprises a motor 616 including a coil 618, a stack (or magnetic support structure) 620, and an armature 622 disposed substantially within the housing 614. Electric currents representing the sounds to be produced are moved through the coil 618. Current through the coil 618 displaces armature 622, which in turn displaces a drive pin, causing a diaphragm to vibrate and create the desired sound. Sound exits through a port in the housing and then through a sound tube 625.

As mentioned, the motor 616 includes the armature 622, the coil 618, and the magnetic support structure 620. The motor 616 also includes at least one magnet 624 that defines a space 626. The coil 618 forms a tunnel 628. The space 626 is defined by the at least one magnet 624 being aligned with the tunnel 628 formed by the coil 618. Portions of the armature 622 extend through the space 626 and the tunnel 628. An opening 630 at an end of the coil 618 is shaped so as to restrict movement of the armature.

Referring now especially to FIG. 14 and FIG. 15, FIG. 14 shows an opening that is a octagon shape with the armature deflecting upward and touching the coil 618 at points 631 and 633 at the opening. FIG. 15 shows an opening that is a octagon shape with the armature deflecting downward and touching the coil 618 at points 635 and 637 at the opening.

In one aspect, portions of the coil 618 are tapered from a first width at a first end of the tunnel 628, to a second width at a second end of the tunnel 628. In another aspect, the opening 630 is shaped as a octagon. In yet another aspect, the opening 630 is shaped as a diamond.

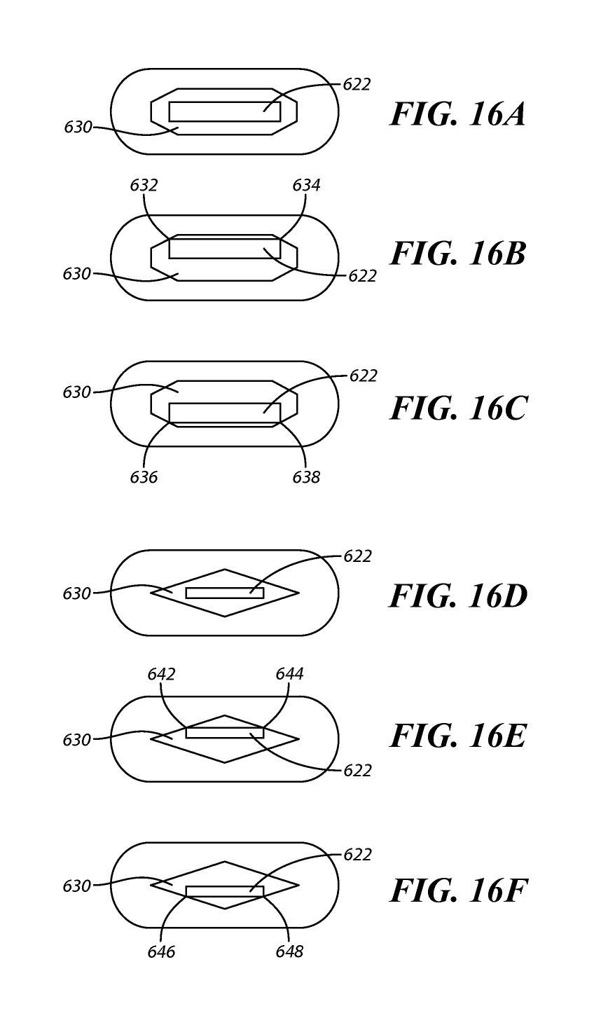

Referring now to FIGS. 16A-16F, various shapes for the end portion of the coil are described. FIG. 16A shows an opening that is a octagon shape with the armature in the middle and not touching the coil 618. FIG. 16B shows an opening that is a octagon shape with the armature deflecting upward and touching the coil 618 at points 632 and 634 at the opening. FIG. 16C shows an opening that is a octagon shape with the armature deflecting downward and touching the coil 618 at points 636 and 638 at the opening.

FIG. 16D shows an opening that is a diamond shape with the armature in the middle and not touching the coil 618. FIG. 16E shows an opening that is a diamond shape with the armature deflecting upward and touching the coil 618 at points 642 and 644 at the opening. FIG. 16F shows an opening that is a diamond shape with the armature deflecting downward and touching the coil 618 at points 646 and 648 at the opening.

In other examples, portions of the coil 618 are tapered and the portions are a first side portion and a second side portion of the tunnel 628. In other examples, portions of the coil 618 are tapered and the portions are a top portion and a bottom portion of the tunnel 28, and a first side portion and a second side portion of the tunnel 628.

It will be appreciated that the coils and receivers provided herein may be constructed according to a variety of different processes and approaches. For instance, the coils can be manufactured using both a wet and dry wind process. By a dry wind process it is meant that the coils are bonded and layered together by the use of induction, convection, and or conductive heating of the thermoset wire. By a wet wind process, it is meant that the coils are constructed by using epoxies, glues, and any other fluid, gel, or paste used as a binding agent. Generally speaking, a dry wind process is more controllable, less costly, and more repeatable.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A motor for an acoustic device, the motor comprising:
an armature;
at least one magnet;
a coil; and
a magnetic support structure;
wherein the at least one magnet defines a space, wherein the coil forms a tunnel, and wherein the space defined by the at least one magnet is aligned with the tunnel formed by the coil; and
wherein portions of the armature extending through the space and the tunnel,
wherein an opening at an end of the coil is shaped so as to restrict movement of the armature.

2. The motor of claim 1, wherein portions of the coil are tapered from a first width at a first end of the tunnel, to a second width at a second end of the tunnel.

3. The motor of claim 1 wherein the opening is shaped as a octagon.

4. The motor of claim 1 wherein the opening is shaped as a diamond.

5. The motor of claim 1, wherein portions of the coil are tapered and the portions are a first side portion and a second side portion of the tunnel.

6. The motor of claim 1, wherein portions of the coil are tapered and the portions are a top portion and a bottom portion of the tunnel, and a first side portion and a second side portion of the tunnel.
